(19) United States
(12) Patent Application Publication
(10) Pub. No.: US 2014/0116117 A1
(43) Pub. Date: May 1, 2014

(54) IMPEDANCE METHOD AND ARRANGEMENT FOR DETERMINING THE COMPOSITION OF A MULTI-PHASE MIXTURE

(71) Applicant: Martin Joksch, St. Andra-Wordern (AT)

(72) Inventor: Martin Joksch, St. Andra-Wordern (AT)

(21) Appl. No.: 14/124,682

(22) PCT Filed: May 14, 2012
(86) PCT No.: PCT/EP2012/058854

§ 371 Date: Dec. 6, 2013

(30) Foreign Application Priority Data
Jun. 8, 2011 (DE) 10 2011 077 202.2

(51) Int. Cl. G01N 27/22

(52) U.S. Cl. CPC G01N 27/22
USPC 73/61.44

(57) ABSTRACT

The invention relates to a method and an arrangement for determining the composition of a multiphase mixture (MG), the multiphase mixture (MG) having at least three phases, in particular mineral oil, water, sand and/or sludge. The multiphase mixture (MG) is conveyed away or led from a delivery point, for example, in a through-flow device (DF), in particular a pipeline. At least two electrodes (E1, E2) for the capacitive management of an impedance (Zx) of the multiphase mixture (MG) are fitted to the through-flow device (DF) so as to be insulated electrically from the multiphase mixture (MG), and a changing electric voltage having a defined amplitude is applied to the multiphase mixture (MG) by a voltage source (VQ), wherein a frequency of said voltage can be adjusted. Then, with the aid of a reference impedance (Zref), a capacitive measurement of the impedance (Zx) of the multiphase mixture (MG) is carried out (2) via the electrodes (E1, E2). By using a measuring unit (ME), a variation in the impedance that depends on a frequency is then determined and impedance spectra are derived (3) from the variation in the impedance (Zx). Then, by means of an evaluation unit (AW), via an evaluation of the impedance spectra, for example by using partial least squares regression, proportions by volume of the respective phase in the multiphase mixture (MG) are derived (4). The method and the associated arrangement have the advantage in particular that interference caused by electrochemical reactions between electrodes (E1, E2) and multiphase mixture (MG) is prevented and therefore the measurement is very robust and can be used flexibly.

### TECHNICAL FIELD

The invention relates to a method together with an arrangement for determining the composition of a multi-phase mixture, where the multi-phase mixture has at least three phases, in particular mineral oil, water, sand and/or sludge. Here, the multi-phase mixture is pumped or fed away, for example by a pumping station, in a flow container, in particular a pipe.

### THE PRIOR ART

In numerous industrial processes, such as for example in the transport of crude oil or mineral oil, so-called multi-phase mixtures are involved which, for example, pass through through-flow equipment (e.g. pipes, tubes, etc.). Here, the problem often arises that it is not only the overall mass flowing through but also the ratio and/or proportions of the various phases within the multi-phase mixture which is important for the efficient progress of the industrial process. A knowledge of the mass through-flow and the ratio of the different phases is important, for example for billing, for the control of the multi-phase pump and in particular for the adjustment of the pumping rate (e.g. in the transport of mineral oil) and for quality monitoring.

In the case of mineral oil transportation, for example, the crude oil which is transported is frequently mixed together with water and natural gas, and is contaminated with sand or sludge. However, for the efficient transportation of mineral oil it is desirable to keep the proportion of unwanted matter (e.g. water, sand, sludge, etc.) as low as possible. Attempts are made to achieve this by suitable process management. However, for this purpose it is necessary to know the composition of the multi-phase mixture which is being transported. For this purpose, a so-called multi-phase flowmeter has been developed since about 1980—in particular for the transportation of mineral oil in the offshore sector. Devices of this type are able to detect two or three phases of a multi-phase mixture—such as for example oil, water and gas.

A multi-phase flowmeter is a device which is used primarily in the mineral oil and natural gas industry, and with which the rates of through-flow of the individual phases (e.g. mineral oil, water, gas) can be measured and monitored, without first separating the phases, during the process of transportation or production of the mineral oil. With this method of phase detection for multi-phase mixtures a distinction can be made, for example, between local measurement and a so-called cross-sectional measurement.

In the case of local measurement needle-shaped sensors, for example, are introduced into the multi-phase mixture. On the basis of the different physical characteristics determined by the sensors it is then possible to recognize the phase of the multi-phase mixture in which the sensor is located at that moment. In doing this, various sensing principles can be deployed—such as for example conductivity, capacitance, thermal conductivity—or use is made for example of electro-chemical and/or optical sensors for making the measurement and for determining the phase concerned. A multi-phase flowmeter of this type which makes use of one or more optical sensors is known, for example, from the “Optical Multiphase Flowmeter” brochure dating from the years 2005-2008 from Weatherford International Ltd., at http://www.weatherford.com/weatherford/groups/web/documents/weatherfordcorp/WFT0 20125.pdf.

With cross-sectional measurement, use is made either of an attenuation of radioactive or X-ray radiation or of a measurement of an impedance or of the electrical conductivity of the mixture, as appropriate, in order to determine the phases concerned or their proportions, as appropriate. From the publication “Vx Technology—Multiphase flow rate measurements without fluid separation” from Schlumberger, dated September 2007, which is published for example at http://www.slb.com/resources/otherresources/brochures/testing/multiphase_vx_technology_brochure.aspx, a method or multi-phase flowmeter, as applicable, is known in which use is made of radioactive irradiation for the purpose of phase determination.

However, the measurement methods for determining the proportions for the phases concerned in a multi-phase mixture have the disadvantage that they frequently have a complex structure. For this reason they are often too expensive for practical uses and are often only suitable for investigations on samples. Further, the known multi-phase flowmeters itemized are mostly restricted solely to the measurement or determination of the phases: mineral oil, water and gas; and therefore cannot detect contamination by sand and/or sludge in a multi-phase mixture.

From the publication US 2006/0265150 A1 are known a method and equipment for the characterization of a multi-phase fluid mixture—above all of two-phase emulsional mixtures (e.g. an oil-water emulsion, sugar-water mixtures, etc.), by which parameters of the multi-phase fluid mixture which are of interest, such as for example the ratio of the phases in the mixture, particle sizes for particles suspended in the mixture and/or characteristics of a bubble foam phase, etc. are detected and/or measured with the help of sensors. Here, the measurement method used is so-called electrical impedance spectroscopy in combination with other sensors for the measurement of, for example, temperature, pH value, etc. of the mixture. To make measurements, the sensors for electrical impedance spectroscopy are in contact with the multi-phase fluid mixture. Impedances are determined for the multi-phase fluid mixture over a frequency range from 0.1 Hz up to 1 MHz, and the appropriate desired parameters are then deduced in a computational unit with the help of a mathematical model.

However, the method and the associated equipment disclosed in the publication US 2006/0265150 A1 have the disadvantage that the sensors for the impedance measurement are in direct contact with the multi-phase fluid mixture. As a result, interference can arise due to electro-chemical reactions between a surface of the sensor and the multi-phase fluid mixture, and can influence the results of the measurement or the measured impedance values, as applicable. This can result in errors in the deduced parameters (e.g. ratio of the phases, etc.), which must be investigated, for example by additional measurements and compensated for by demanding and high-cost post-processing and/or extensions to the mathematical model used for the evaluation.

The method disclosed in the publication US 2006/0265150 A1 has disadvantages even when used in a so-called flowmeter—in particular in the case of the transportation and/or processing of mineral oil, because it can take a relatively long time to determine the composition of a multi-phase mixture, due to the low frequency range used for the measurement, from 0.1 Hz up to 1 MHz. Thus, for example, at a frequency of 0.1 Hz it requires about 5 to 10 seconds to record the one measurement point for the impedance spectrum, and the recording of a complete spectrum can as a result last for a minute or longer. Consequently it is only with difficulty, or not at all, possible to react to rapid changes to the composition (e.g. transitions between phases, which change rapidly, contaminants, etc.), so that it may be that the composition of the multi-phase mixture can only be incorrectly determined. In addition, with the method presented in the publication US 2006/0265150 A1, it is also impossible to detect contamination by sand and/or sludge, or their proportion in a multi-phase mixture, as applicable.

### PRESENTATION OF THE INVENTION

The objective underlying the invention is therefore to specify a method and an arrangement by which it is possible in a simple and cost-effective manner to determine the composition of a multi-phase mixture without measurement errors and/or distortion, even when there are rapid changes.

In accordance with the invention, the objective is achieved by a method together with an arrangement of the nature set out in the introduction, by the characteristics described in the corresponding claims 1 and 9. Advantageous embodiments of the method or arrangement, as applicable, are itemized in the dependent claims.

In accordance with the inventive method, provision is made that electrodes which are electrically isolated from the multi-phase mixture are attached to flow-through equipment for the multi-phase mixture. A changing electric voltage with a defined amplitude, in particular an alternating voltage, is then applied to the multi-phase mixture, whereby the frequency can be adjusted. A capacitance measurement of the impedance of the multi-phase mixture is then made continuously across the electrodes and a graph of the impedance against frequency is then determined with the help of a measurement unit. From the impedance graph determined, impedance spectra are then determined with the help of the measurement unit, and from an analysis of the impedance spectra by an analysis unit, the proportions by volume of each of the phases in the multi-phase mixture are deduced.

The main aspect of the solution proposed by the invention consists in the fact that the insulated electrodes make it possible to ensure that a measurement of the impedance, in particular, is not distorted by electro-chemical reactions at the electrodes. Measurement of the impedance of the multi-phase mixture thus becomes, in a simple and cost-effective way, more robust and more stable. In the determination of a frequency-dependent impedance graph or of the impedance spectra, as applicable, and in an analysis of the measurement results or impedance spectra respectively, it is thus not necessary to carry out any demanding and complex corrections, etc. of possible distortions. The inventive procedure supplies volumetric proportions—in particular even for more than two phases in a multi-phase mixture, and also for the proportions of sand and/or sludge—with a relatively good accuracy (approx. 5 to 10%).

It is advantageous if the impedance spectra which are deduced, and/or the volumetric proportions determined for the phase concerned of the multi-phase mixture, are output and displayed via an output unit. This enables measured and/or determined values—such as for example impedance graphs for the phases concerned, impedance spectra, volumetric proportions, etc.—to be displayed in a simple and rapid manner, and it is possible without great effort to read off the composition or a change in the composition of the multi-phase mixture.

It is expedient if the electrodes are attached to the outside of an outer wall of the flow-through equipment. In this simple way, the electrodes are electrically isolated from the multi-phase mixture by the outer wall of the flow-through equipment. Without great cost, this prevents electro-chemical disturbances in the making of the measurements. In addition, the electrodes can in this way be easily attached and removed again when needed, for example if a measurement is to be made at another point on the flow-through equipment.

In the case of more complex measurement sites, or if a position for the attachment of electrodes for an impedance measurement on a multi-phase mixture is accessible from outside only with difficulty, or hardly at all, there is the alternative possibility of attaching the electrodes inside the flow-through equipment but electrically isolated from the multi-phase mixture. Appropriate attachment and isolation from the multi-phase mixture also prevents electro-chemical reactions at the electrodes which lead to disruption and errors in the impedance measurement.

Ideally, the analysis of the impedance spectra will be carried out using so-called partial least squares regression—PLS for short. PLS is a statistical method for a multi-variant analysis, which is used for example in order to find relationships between two matrices—e.g. a latent variables approach for modeling covariance structures in matrix spaces. PLS is also used, for example, in so-called near-infrared spectroscopy (NIR Spectroscopy) for analytical purposes, and in the analysis of impedance spectra also provides a determination of the volumetric proportions of each of the phases in a multi-phase mixture with a relatively good accuracy, of approx. 5 to 10%.

For a determination of the composition of a multi-phase mixture it is advantageous if the electrodes are used to record an impedance spectrum in a frequency range from 10 kHz up to 20 MHz. Practical experiments in determining volumetric proportions on multi-phase mixtures with at least three phases, in particular a mixture of oil, water and sand or sludge, have shown that in this frequency range a measurement of the impedance using electrically isolated electrodes—in particular attached to the outer wall of the flow-through equipment—achieves good values for the determination of the volumetric proportions of each of the phases and for transitions between the phases. Also, in this frequency range the inventive method's susceptibility to error and disruption is rather low. Apart from this, in the frequency range from 10 kHz up to 20 MHz measurements can be carried out relatively rapidly, because this frequency range is sufficiently high to permit the recording of several impedance spectra per second. This is particularly advantageous when the invention is used in a multi-phase flowmeter.

An expedient development of the inventive method provides that in making the capacitance measurement of the impedance of the multi-phase mixture use is made of a reference impedance, in particular a capacitance. When an alternating voltage, or an electrically changing field associated with it, is applied the multi-phase mixture behaves like a dielectric material in which, as a result of the movement of the dipoles (=dielectrical relaxation) and the charge carriers, evoked by the applied alternating field, it is possible to measure an impedance—in particular a capacitance—indirectly through voltage drops. In order to be able to determine this impedance which, because of their differing dielectric constants, conductivity, etc., has a frequency-dependent graph which depends on the phase, phase transition, etc. of the multi-phase mixture, a third voltage value is required in addition to the applied voltage and the voltage drop measured across the electrodes. This reference value is determined with the help of the reference impedance, which ideally is in the form of a capacitance because the impedance of the multi-phase mixture measured using these (isolated) electrodes has a mainly capacitive value, due to the attachment used for the electrodes in the inventive method.

Furthermore, it is to be recommended that so-called cross-sectional sensors are used as the electrodes, because cross-sectional sensors can be attached in a simple manner—in particular on outer walls of flow-through equipment—for the purpose of measuring the impedance of a multi-phase mixture.

The solution to the objective posed is achieved in addition by an arrangement of the type stated in the introduction, for carrying out the inventive method, which in addition to flow-through equipment for the multi-phase mixture incorporates in addition at least two electrodes, for the capacitance measurement of an impedance of the multi-phase mixture, which are attached to the flow-through equipment so that they are electrically isolated from the multi-phase mixture. Additionally, the inventive arrangement includes a voltage source, through which it is possible to apply to the multi-phase mixture a changing voltage, in particular an alternating voltage with a defined amplitude and adjustable frequency, a reference impedance, in particular a capacitance, a measurement unit for determining a graph of the measured impedance as a function of the frequency and for determining the associated impedance spectra, together with an analysis unit for determining the volumetric proportions of each of the phases in the multi-phase mixture.

The main aspect of the arrangement proposed in accordance with the invention consists primarily in the fact that the use of electrically isolated electrodes ensures that a measurement of the impedance—with the help of a voltage source and a reference impedance, for example by means of the so-called IU method whereby an impedance is determined indirectly by reference to three known voltage drops (applied alternating voltage, voltage drop across the reference impedance and measured voltage drop across the multi-phase mixture)—is not disrupted by electro-chemical reactions at the electrodes. The inventive arrangement thus provides, in a simple and cost-effective way, a robust and stable measurement of the impedance of the multi-phase mixture.

The measurement unit of the inventive arrangement then determines a frequency-dependent impedance graph, and from that determines the corresponding impedance spectra in the selected frequency range (e.g. 10 kHz up to 20 MHz). Here, the frequency range is selected to be such that it is sufficiently high to keep any influence of the electrode insulation small, but that it lies within a range in which it is still possible to make good measurements using analog components (e.g. capacitors, etc.). Apart from this, impedance spectra can be measured or recorded, as applicable, rapidly in the selected frequency range—i.e. several spectra recorded per second. In measuring the impedance or impedance spectra use is made, for example, of so-called dielectric impedance spectroscopy, in which no corrections are made, or no disruption and errors due to electro-chemical reactions at the electrodes must be taken into account.

In an analysis unit, the volumetric proportion of each of the phases—in particular also the proportions of sand and/or sludge in an oil-water mixture, for example—is then deduced by reference to the impedance spectra, for example by means of PLS. Its simple construction and simplicity of use make the arrangement cost-effective and simple to deploy in practice—e.g. in the case of mineral oil transportation and processing—for example to determine the volumetric proportions of more than two phases in a mixture. Thus the inventive arrangement, and with it also the inventive method, can—again because of the selected frequency range—be very simply applied in a so-called multi-phase flowmeter.

It is advantageous if an output unit is provided for the output and display of the impedance spectra and of the volumetric proportions which have been determined for each phase in the multi-phase mixture. The values determined—such as for example the impedance graphs for each of the phases, impedance spectra, volumetric proportions etc.—can be output rapidly and efficiently on this output unit, for example as numerical values or in the form of graphic curves.

### BRIEF DESCRIPTION OF THE DRAWING

The invention is explained below by way of examples, by reference to the attached figures. These show:

FIG. 1: as an example, and schematically, a sequence of activities in the inventive method for determining the composition of a multi-phase mixture, together with the associated arrangement for carrying out this method

FIG. 2: in an exemplary and schematic form, a structure for the measurement/determination of an impedance for the multi-phase mixture, with electrodes and measurement unit.

### EMBODIMENT OF THE INVENTION

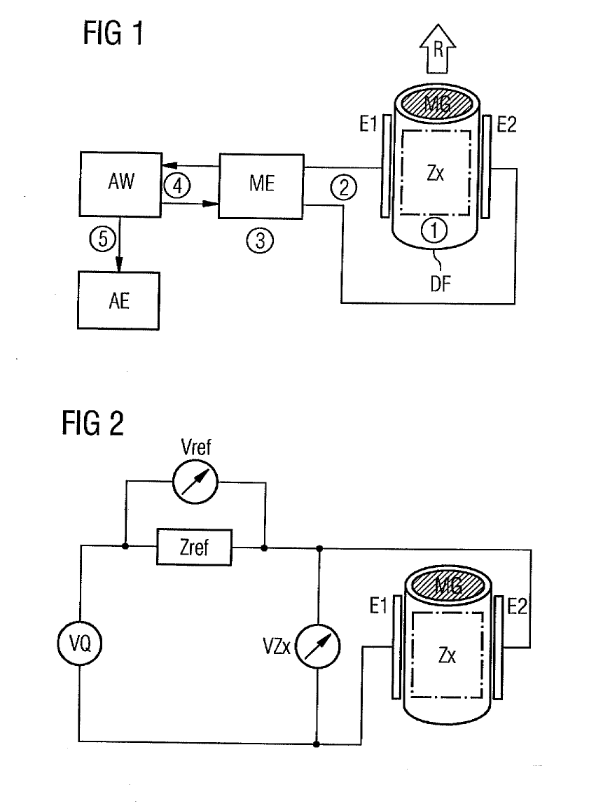

FIG. 1 shows by way of example and in schematic form the inventive arrangement, together with a sequence of activities in accordance with the inventive method for determining the composition of a multi-phase mixture MG, which could be made up for example of a mixture of mineral oil, water, sand and/or sludge. This multi-phase mixture MG flows through through-flow equipment DF such as, for example, a pipe or a conduit, for example in the direction R.

At least two electrodes E1, E2 are attached to an outer wall of the through-flow equipment DF, and are thereby electrically isolated from the multi-phase mixture MG. These electrodes E1, E2 can be in the form of so-called cross-section sensors. Alternatively however, it is also conceivable that the electrodes E1, E2 are in the form of insulated electrodes E1, E2 and are located within—e.g. on an inside wall of—the through-flow equipment DF.

Using the electrodes E1, E2, a capacitance measurement is made of an impedance Zx of the multi-phase mixture MG. To this end, in a first method step 1 a changing electric voltage with a defined amplitude is applied from a voltage source VQ—as shown in FIG. 2—to the multi-phase mixture MG. The changing voltage or changing electric field, as applicable, effects in the multi-phase mixture MG a movement of the charge carriers or dipoles, as applicable, which is also referred to as electrical relaxation. Due to the differing dielectric constants or differing conductivities of each of the phases of the multi-phase mixture MG, and the differing relaxation processes at the phase boundaries, it is then possible in a second method step 2 to measure via the electrodes E1, E2 an impedance Zx of the multi-phase mixture. Here, this impedance Zx has a graph which is frequency-dependent and thus permits conclusions to be drawn about the composition of the multi-phase mixture MG.

A measurement of the impedance Zx is made—as shown by way of example in FIG. 2—for example in accordance with the so-called IU method, with the help of a reference impedance Zref, which can for example be implemented as a capacitance. The component used for the construction of the corresponding measurement circuit can be a capacitor. The voltage from the source VQ, which is imposed on the multi-phase mixture MG, produces on the one hand a voltage drop Vref across the reference impedance Zref and, on the other hand, a voltage drop VZx across the impedance Zx of the multi-phase mixture MG. The voltage drop VZx is then measured via the electrodes E1, E2. On the basis of the three known voltage values VQ, Vref and VZx together with the known reference impedance Zref it is then possible to determine the unknown impedance Zx of the multi-phase mixture MG—for example with the help of the measurement unit ME.

The electrodes E1, E2 are—as shown schematically in FIG. 1—connected to a measurement unit ME, where the measurement unit ME can incorporate the structure shown schematically and by way of example in FIG. 2 for the determination of the impedance Zx, in particular the source VQ for producing the changing electric voltage with a defined amplitude and adjustable frequency or the changing electric field, as applicable, together with the reference impedance Zref.

A third method step 3 then determines for the multi-phase mixture MG a graph against frequency of the impedance Zx which has been determined, e.g. in a frequency range from 10 kHz up to 20 MHz, by capacitance measurements using the electrodes E1, E2. From this graph, impedance spectra are then deduced in the measurement unit ME—for example by so-called dielectric impedance spectroscopy.

The measurement unit ME is connected to an analysis unit AW, which can be in the form of a PC or a microcontroller, and data (e.g. impedance spectra etc.) are exchanged between the measurement unit and the analysis unit.

In a fourth method step 4, the data which is then supplied from the measurement unit ME, such as for example the impedance spectra for the measured impedance Zx of the multi-phase mixture MG, is analyzed by the analysis unit, e.g. using partial least squares regression (PLS). It is thereby possible to deduce from the impedance spectra the volumetric proportions of each of the phases in the multi-phase mixture MG.

Also connected to the analysis unit AW is an output unit AE, via which result data can be output and/or displayed in a fifth method step 5. In doing so it is possible, for example, to display the differing graphs of the impedance Zx against frequency for each of the phases in the form of graphic curves or as numeric values. Apart from this, the volumetric proportions of each of the phases of the multi-phase mixture MG deduced from the various impedance spectra can also be output—e.g. in tabular form—whereby the analysis using PLS shows that the volumetric proportions of the phases can be determined with an accuracy of approx. 5 to 10%, and hence is relatively robust.

The inventive method together with the arrangement are in addition insensitive to electro-chemical reactions and any resulting distortions at the electrodes E1, E2 due to interactions with the multi-phase mixture MG—because of the electrical isolation or electrically insulated attachment of the electrodes E1, E2, as applicable. In addition, the arrangement and hence the method can be applied in a simple manner in multi-phase flowmeters.

1. A method for the determination of the composition of a multi-phase mixture (MG), where the multi-phase mixture (MG), which consists of at least three phases, in particular mineral oil, water, sand and/or sludge, flows through flow-through equipment (DF), in particular a pipe, characterized in that electrodes (E1, E2) are attached to the flow-through equipment (DF) in such a way that they are electrically isolated from the multi-phase mixture (MG), that a changing electric voltage (VQ) with a defined amplitude and adjustable frequency is applied to the multi-phase mixture (MG) (1), that a capacitance measurement of an impedance of the multi-phase mixture (MG) is then made via the electrodes (E1, E2) (2), that a graph of the impedance (Zx) as a function of frequency is determined using the electrodes in a frequency range from 10 kHz to MHz, and that from an analysis of the impedance spectra which have been determined the volumetric proportions of each phase in the multi-phase mixture (MG) are then deduced by means of an analysis unit (AW).

2. The method as claimed in claim 1, characterized in that impedance spectra which have been determined and/or volumetric proportions which have been deduced for each of the phases of the multi-phase mixture (MG) are output and displayed via an output unit (AE) (5).

3. The method as claimed in claim 1, characterized in that the electrodes (E1, E2) are attached on the outer side of an outer wall of the flow-through equipment (DF).

4. The method as claimed in claim 1, characterized in that the electrodes (E1, E2) are attached within the flow-through equipment (DF) in such a way that they are electrically isolated from the multi-phase mixture (MG).

5. The method as claimed in claim 1, characterized in that the analysis of the impedance spectra is performed using so-called partial least squares regression (PLS).

6. (canceled)

7. The method as claimed in claim 1, characterized in that the capacitance measurement of the impedance (Zx) of the multi-phase mixture (MG) is made using a reference impedance (Zref), in particular a capacitance.

8. The method as claimed in claim 1, characterized in that so-called cross-sectional sensors are used as the electrodes (E1, E2).

9. An arrangement, where flow-through equipment (DF), in particular a pipe, is provided for a multi-phase mixture (MG) which consists of at least three phases, in particular mineral oil, water, sand and/or sludge, characterized in that further provisions are:
for the purpose of capacitance measurement of an impedance (Zx) of the multi-phase mixture (MG), at least two electrodes (E1, E2) which are electrically isolated from the multi-phase mixture (MG) are attached to the flow-through equipment (DF),
a voltage source (VQ) for applying a changing voltage, in particular an alternating voltage, with a defined amplitude and adjustable frequency,
a reference impedance (Zref), in particular a capacitance,
a measurement unit (ME) for determining a graph against frequency of the measured impedance in a frequency range from 10 kHz to 20 MHz,
an analysis unit (AE) for determining volumetric proportions of each of the phases in the multi-phase mixture by an analysis of the impedance spectra.

10. The arrangement as claimed in claim 9, characterized in that an output unit (AE) is provided for the output and display of impedance spectra which have been deduced and/or the volumetric proportions which have been determined for each phase in the multi-phase mixture (MG).
